(19) United States
(12) Patent Application Publication
(10) Pub. No.: US 2025/0374939 A1
(43) Pub. Date: Dec. 11, 2025

(54) WATERLESS PASTA PRODUCT AND METHOD OF MAKING THE SAME

(71) Applicant: Domenico Lomuto, Los Angeles, CA (US)

(72) Inventor: Domenico Lomuto, Los Angeles, CA (US)

(21) Appl. No.: 18/738,519

(22) Filed: Jun. 10, 2024

(51) Int. Cl. A23L 7/109; A23L 5/10; A23L 23/00

(52) U.S. Cl. CPC A23L 7/109; A23L 5/15; A23L 7/111; A23L 23/00

(57) ABSTRACT

A unique way to cook dry, not precooked, and not refrigerated or frozen pasta either in a microwave oven or pan, is disclosed.

### BACKGROUND OF THE INVENTION

Traditional pasta dishes often demand time-consuming preparation, including cooking and cleanup, which poses a challenge for busy individuals who seek a delicious meal without sacrificing time and convenience. Furthermore, ready-made pasta options often fall short in delivering the authentic taste and quality of homemade recipes. There is a clear demand for a solution that offers the convenience of quick preparation without compromising the flavor and quality of the dish.

The present invention is directed at overcoming shortcomings with conventional products and methods and relates to a pasta product that does not need to be cooked in water and methods of making the same.

### SUMMARY OF THE INVENTION

In one aspect of the present invention, the invention is directed at methods of cooking pasta without adding water.

In another aspect of the present invention, the invention is directed at a package comprising one or more packets of pasta together with one or more packets of sauce, and wherein the pasta can be cooked in the sauce either in a microwave or in a pan on a stovetop, without any water being used.

These and other features, aspects and advantages of the present invention will become better understood with reference to the following drawings, description and claims.

### BRIEF DESCRIPTION OF THE DRAWINGS

FIG. 1 is a flowchart depicting methods of making a waterless pasta product in accordance with preferred embodiments of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a pasta product that does not need to be cooked in water, and also relates to methods of making the same. As stated above, traditional pasta dishes often demand time-consuming preparation, including cooking and cleanup, which poses a challenge for busy individuals who seek a delicious meal without sacrificing time and convenience. Furthermore, ready-made pasta options often fall short in delivering the authentic taste and quality of homemade recipes. There is a clear demand for a solution that offers the convenience of quick preparation without compromising the flavor and quality of the dish. The invention claimed here solves this problem.

Bravo Bravissimo (the tradename of the pasta product of the present invention) revolutionizes the way pasta is prepared by introducing a revolutionary and unique cooking method that eliminates the need for water, allowing for rapid and hassle-free preparation without compromising on taste or quality.

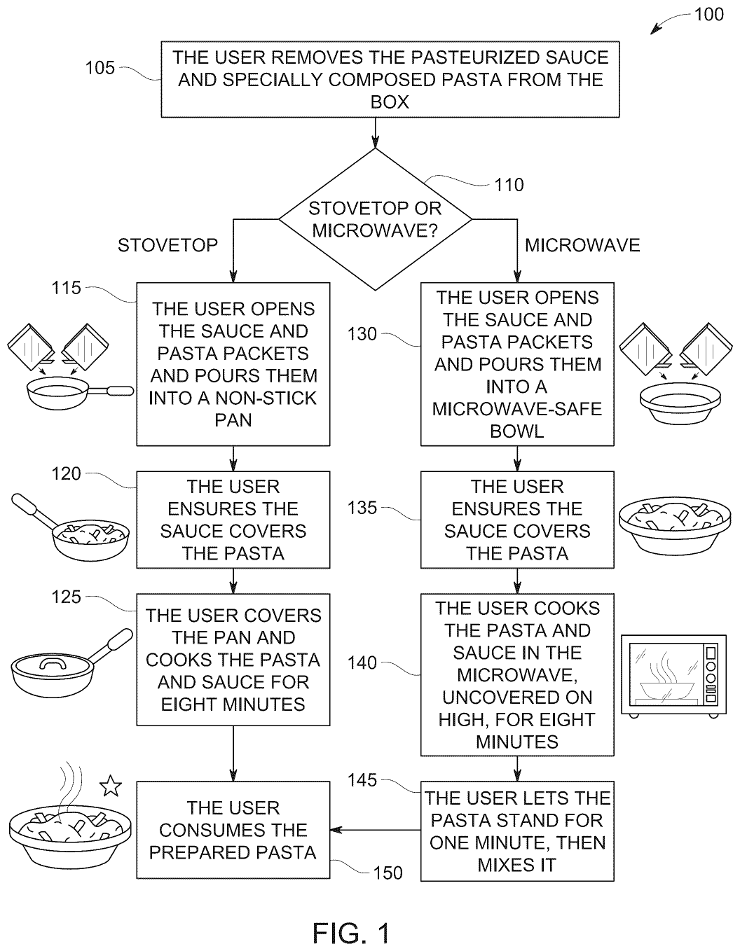

As discussed in more detail below, and as depicted in FIG. 1 hereto, in just a matter of minutes customers can indulge in a truly authentic Italian pasta dish unlike anything they have experienced before.

The method (100) first comprises the user removing the pasteurized sauce packet(s) and specially composed pasta packet(s) from the box or other container (105). Method 100 is then customized depending on whether the user elects to utilize a stovetop or microwave oven to prepare the pasta (110). If a microwave oven is selected at step 110, then the user opens the pasta packet(s) and places the pasta into a microwave-safe bowl. The user then opens the sauce packet(s) and pours the content(s) over the pasta in the microwave-safe bowl (130). In a preferred embodiment, the bowl is included in the same package as the sauce and pasta. At this time, the user should ensure that the sauce covers the pasta (135). The user then cooks the pasta and sauce in the microwave oven, uncovered and on high, for eight minutes (140). The user next takes the bowl out of the microwave oven and lets the pasta one minute before mixing the sauce and pasta together (145), after which the user can consume the pasta product (150).

In the event the user elects to use a stovetop to cook the pasta, the user would open the pasta and sauce packet(s) and pour them into a non-stick pan (115). The user should ensure that the sauce covers the pasta (120). The user then covers the pan and cooks the pasta and sauce for eight minutes (125), after which the user can consume the pasta (150).

In a preferred embodiment, the pasta within the packet(s) is a dry wheat-based pasta that is not precooked, not frozen, and is shelf stable for at least 12 months.

More specifically, a preferred pasta for use in connection with the present invention is Durum Wheat Semolina Pasta, and has the following characteristics:
Shelf-life: 36 months (TMA: up to 75% of the product life)
Physical and Chemical Characteristics:
   Moisture at 130° C.: ≤12.50%.
   Ash at 550° C.: max 0.90%
   Total Kjeldahl Nitrogen: min 10.50%.
   Acidity: max 4%
Ingredients: Durum wheat semolina (OGM free)
Nutritional Information (per 100 g):
   Energy: 1511 kJ (356 kcal)
   Fat: 1.5 g (of which saturates: 0.3 g).
   Carbohydrate: 71.5 g (of which sugars: 3.5 g).
   Fiber: 3 g.
   Protein: 12.5 g.
   Salt: 0.01 g
Sensory Characteristics:
   Color: Typical pale yellow of durum wheat semolina.
   Smell: Characteristic of wheat
   Texture: Solid structure without breaks or obvious marks

In a preferred embodiment, the sauce within the packet(s) includes a predetermined amount of extra water already added which allows the pasta to cook perfectly without adding anything else (including water).

In a preferred embodiment, the sauce used in connection with the present invention has a shelf stability of over 18 months and is achieved through a process that combines liquidity index control and double pasteurization. Here is how the process works:

### Liquidity Index Control

The liquidity index of the sauce is regulated to maintain an optimal consistency. This means the sauce has a balanced water content, which not only prevents the separation of components but also promotes uniform heat penetration during pasteurization. The consistency of the sauce allows for the rehydration of the pasta during cooking without the need for additional water.

### Double Pasteurization

1. First Pasteurization: During the first phase of pasteurization, the sauce is heated to a specific temperature for a determined period. This process eliminates most pathogenic and spoilage microorganisms present in the sauce.
2. Second Pasteurization: The second phase occurs after the sauce has been packaged. The packaged product is reheated to ensure that any residual microorganisms are eliminated, thereby ensuring the long-term stability of the product. This double thermal treatment is essential to destroy any bacterial spores that may have survived the first pasteurization.
   Shelf Stability and Cooking without Added Water

The precise control of the liquidity index and the double pasteurization process not only ensure the microbiological safety and shelf stability of the product but also make it possible to cook the pasta without adding extra water. The sauce's balanced consistency allows it to adequately rehydrate and cook the pasta, providing a convenient and ready-to-eat meal with a shelf life of over 18 months.

As discussed above, in a preferred embodiment the package includes a microwave safe bowl. The bowl is appropriately sized to make sure the included sauce covers the pasta when cooking.

Bravo Bravissimo's focus on combining technology and culinary expertise to deliver an authentic Italian taste in minutes positions it well to take advantage of these industry trends. By offering a product that is easy to prepare, does not require refrigeration, and can be shipped directly to consumers, Bravo Bravissimo has the potential to carve out a unique position in the pasta market.

It should be understood, of course, that the foregoing relates to exemplary embodiments of the invention and that modifications may be made without departing from the spirit and scope of the invention as set forth in the following claims.

What is claimed is:

1. A method of cooking pasta without water, the method comprising:
placing a predetermined amount of wheat-based pasta in a microwave-safe bowl;
placing a predetermined amount of sauce over the pasta and ensuring the sauce covers the pasta;
placing the bowl, uncovered, in a microwave oven;
cooking the pasta and sauce mixture at high for approximately eight minutes;
removing the bowl from the oven and letting it rest for one minute before serving.

2. A method of cooking pasta without water, the method comprising:
placing a predetermined amount of wheat-based pasta in a non-stick pan;
placing a predetermined amount of sauce over the pasta and ensuring the sauce covers the pasta;
covering the pan and cooking the pasta and sauce mixture for approximately eight minutes;
removing the pan from the stovetop and letting it rest for one minute before serving.

3. A package containing pasta and sauce that can be cooked in a microwave or stove top without requiring water, the package comprising:
one or more packets containing a predetermined amount of wheat-based, non-precooked or frozen pasta;
one or more packets containing a double pasteurized sauce mixture that includes a predetermined amount of added water included therein;
wherein the amount of sauce within the one or more packets is designed to cover the pasta when the pasta is placed in a container for cooking.

4. The pasta and sauce package of claim 3, further comprising a microwave safe bowl that is sized to ensure the sauce covers the pasta when cooking.
